(19) United States
(12) Patent Application Publication
(10) Pub. No.: US 2017/0060226 A1
(43) Pub. Date: Mar. 2, 2017

(54) APPARATUS AND METHOD FOR SUPPLYING POWER TO A MOBILE ELECTRONIC DEVICE

(71) Applicants: Yariv ERAD, Kidron (IL); Menachem ERAD, Ashdod (IL)

(72) Inventors: Yariv ERAD, Kidron (IL); Menachem ERAD, Ashdod (IL)

(21) Appl. No.: 15/120,520

(22) PCT Filed: Mar. 12, 2015
(86) PCT No.: PCT/IL15/50264

§ 371 Date: Aug. 21, 2016

Related U.S. Application Data
(60) Provisional application No. 61/954,865, filed on Mar. 18, 2014.

(51) Int. Cl. G06F 1/32; G06F 1/26

(52) U.S. Cl. CPC G06F 1/3287; G06F 1/263

(57) ABSTRACT

The subject matter discloses a mobile electronic device, comprising two or more power consumption modules, two or more power suppliers for providing power to the two or more power consumption modules, and a computerized control unit for adjusting a configuration in which power is supplied to the two or more power consumption modules by the two or more power suppliers from a first power supply configuration to a second power supply configuration.

### FIELD OF THE INVENTION

The invention generally relates to power supply.

### BACKGROUND OF THE INVENTION

The growing proliferation and usage of mobile devices and mobility in recent years have pushed the user experience efforts and investments to new heights. The influence of the pursuit of simplicity and ease-of-use, and the huge amount of SW application have created two interesting observations:
The age barrier has been broken—people from 2-3 years old to elderly persons 80-90 years old are using variety of applications, on the move, connected all the time, capturing, sharing and viewing photos, data, audio, and interacting with the mobile devices via touch-based interfaces;
The demand for new features and innovation is growing, becoming close to obsession—while causing fast obsolescence of the previous generation of innovation.

The implication of facing such growing demand for new applications, new UX, and new innovations—means integrating more components in the same device sizes, as they need to remain mobile—and this in turn means expending technological development in different areas.

Therefore, we see acceleration in the development and integration in mobile device of processing power, graphical processing power, photography HW and image processing, integration of audio, image, video, effects, editing, sharing, data from sensors—GPS, movement, environmental, health, fitness—location-based data, including awareness, directional, sensing, and various wireless communication capabilities—cellular, Wi-Fi, BT, BLE, LTE, etc.

The common factor for all these elements is that they are all power consumers.

The implications are that the ability to provide power and the ability to prolong battery usage between charging or requiring the user to use an external battery accessory become critical in the ability and rate of implementing and integrating new features and capabilities—which are the driving force behind the UX, and the driving force behind the market growth and user pace of device replacement.

The limitations dictated by the form-factor of Mobility devices—mainly size and weight—require a more efficient power source, while reducing their size and weight. The growing interaction between components, and the growing ability to operate several features in parallel—for example, navigation, gaming, and conversation—require a growing sophistication of the power allocation management SW;

The main efforts to improve the power consumption are based on technological improvement in batteries technology, and are based on the assumption that a single battery is allocated to a device.

Two main efforts can be identified, and are implemented in parallel:

1. Reducing the power consumption per component;

2. Increasing the power capacity provided by the battery—resulting in a slow process, 2-3% improvement a year.

### SUMMARY OF THE INVENTION

A mobile electronic device, comprising two or more power consumption modules, two or more power suppliers for providing power to the two or more power consumption modules; a computerized control unit for adjusting a configuration in which power is supplied to the two or more power consumption modules by the two or more power suppliers from a first power supply configuration to a second power supply configuration.

In some cases, the mobile electronic device further comprises a display mean.

In some cases, said display mean can be used for displaying a map of associating the two or more power suppliers and two or more power suppliers.

In some cases, the mobile electronic device further comprises an input unit for receiving an input from a user of one of the two or more power consumption modules, said input concerns allocation of one of the two or more power suppliers to the one of the two or more power consumption modules.

The mobile electronic device of claim 1, wherein a first power supplier of the two or more power suppliers has a different property than a second power supplier of the two or more power suppliers.

The mobile electronic device of claim 1, wherein a first power supplier of the two or more power suppliers is identical to a second power supplier of the two or more power suppliers.

In some cases, the mobile electronic device further comprises a switching unit connected to the computerized control unit for changing allocation of a power supplier of the two or more power suppliers to the one of the two or more power consumption modules.

In some cases, the switching unit enables a power supplier of the two or more power suppliers to function when another power supplier of the two or more power suppliers cannot supply power.

In some cases, changing allocation of a power supplier of the two or more power suppliers to the one of the two or more power consumption modules responsive to a predefined event or a predefined set of rules.

In some cases, the mobile electronic device further comprises a transmission unit for transmitting indication concerning battery status of at least one of the two or more power suppliers to a remote device.

In some cases, the transmission unit for transmitting indication concerning battery status responsive to a predefined event.

In some cases, the mobile electronic device further comprises a monitoring unit that enables a remote device to remotely monitor power consumption of the two or more power consumption modules.

In some cases, the mobile electronic device further comprises a physical connector to enables replacing a single power supplier with two or more power suppliers, such that each of the replacing two or more power suppliers can supply power to the two or more power consumption modules.

In some cases, the mobile electronic device further comprises two or more compartments for storing the two or more power suppliers, wherein a power supplier of the two or more power suppliers adapted to provide power to a specific power consumption module is stored in a compartment located near the specific power consumption module.

In some cases, the mobile electronic device further comprises a charging connector configured to charge a portion of the two or more power suppliers simultaneously.

In some cases, the mobile electronic device further comprises an internal power charging unit for transferring power between power suppliers of the two or more power suppliers.

In some cases, a package of power suppliers of the two or more power suppliers are dedicated to a specific power consumption module of the two or more power consumption modules.

In some cases, the mobile electronic device further comprises a solar charging unit for absorbing light from an external source and converting the light to electrical power.

It is another object of the subject matter to disclose a method for managing power allocation in a mobile electronic device comprising obtaining a mobile electronic device, comprising two or more power consumption modules and two or more power suppliers for providing power to the two or more power consumption modules, adjusting a configuration in which power is supplied to the two or more power consumption modules by the two or more power suppliers from a first power supply configuration to a second power supply configuration.

In some cases, the method further comprises receiving a value indicating a priority of one of the two or more power consumption modules and adjusting the configuration in which power is supplied to the two or more power consumption modules according to said value.

In some cases, the method further comprises receiving a value indicating a power reserve of one of the two or more power consumption modules and adjusting the configuration in which power is supplied to the two or more power consumption modules according to said value.

In some cases, the method further comprises receiving a value indicating a charging status of one of the two or more power consumption modules and adjusting the configuration in which power is supplied to the two or more power consumption modules according to said value.

In some cases, adjusting a configuration in which power is supplied to the two or more power consumption modules comprises activating or deactivating one of the two or more power consumption modules.

In some cases, adjusting a configuration in which power is supplied to the two or more power consumption modules according to an application operating on the mobile electronic device.

In some cases, the method further comprises displaying a map of associating which power supplier supplies power to each power consumption module.

In some cases, adjusting a configuration in which power is supplied to the two or more power consumption modules is performed in response to a command from a remote device.

In some cases, the method further comprises monitoring power allocation of the two or more power consumption modules from the remote device.

In some cases, the method further comprises determining a power allocation plan of the two or more power consumption modules at the remote device.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B show a mobile electronic device comprising two or more power suppliers, in accordance with a preferred embodiment of the invention;

FIG. 2A shows an optional power supply configuration in which power suppliers are allocated to power consumption modules, in accordance with a preferred embodiment of the invention;

FIG. 2B shows an optional power supply configuration in which power suppliers are allocated to various sensors, in accordance with a preferred embodiment of the invention;

FIG. 3A shows a method for allocating power suppliers to power consumption modules, according to exemplary embodiments of the disclosed subject matter;

FIG. 3B shows a method for prioritizing power consumption modules when allocating power, according to exemplary embodiments of the disclosed subject matter;

FIGS. 4A and 4b show an arrangement of multiple power suppliers in a power compartment, according to exemplary embodiments of the disclosed subject matter;

FIG. 5 shows a table that shows usage of multiple power suppliers, according to exemplary embodiments of the disclosed subject matter;

FIGS. 6A-6C show several sections of a display device having power allocated thereto in a separate configuration, according to exemplary embodiments of the disclosed subject matter;

FIG. 7 shows a method of controlling power allocation to a mobile electronic device from a remote device, according to exemplary embodiments of the subject matter;

FIG. 8 shows a packaging of an array of power suppliers to a mobile electronic device, according to exemplary embodiments of the subject matter;

FIG. 9 shows a power supplier with sub-units of another power supplier in a power compartment, according to exemplary embodiments of the subject matter; and,

FIG. 10 shows a method of charging a mobile electronic device from a remote device, according to exemplary embodiments of the subject matter.

### DETAILED DESCRIPTION OF THE INVENTION

The present invention discloses an electronic device comprising two or more power suppliers and a computerized unit for managing power allocation from the two or more power suppliers to various power consumption units of the electronic device. The computerized unit enables adjusting power allocation from the two or more power suppliers, for example responsive to a predefined event, as disclosed below.

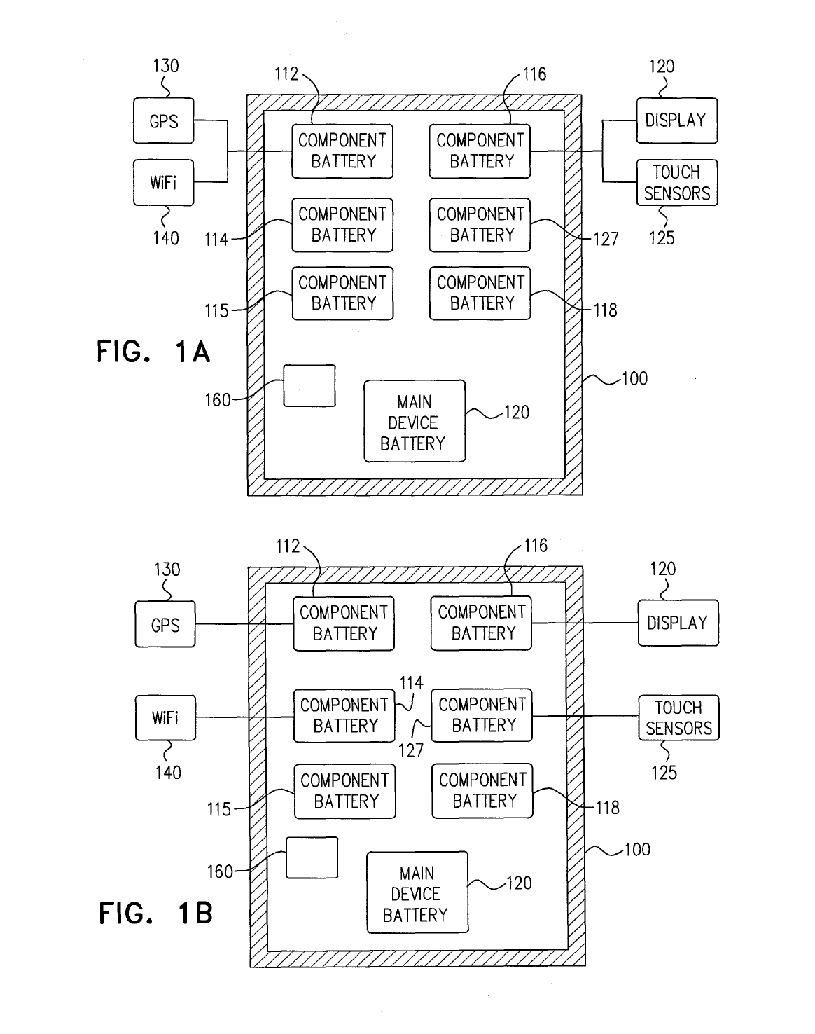

FIGS. 1A and 1B shows a mobile electronic device comprising two or more power suppliers, in accordance with a preferred embodiment of the invention. The mobile electronic device 100 may be a telephone, a tablet computer, a PDA, a laptop, an Internet Of Thing (IOT) device and/or sensor or any other mobile device having two or more electronic modules that consume power. The mobile electronic device 100 comprise power consumption modules such as a display device 120, touch sensors 125, GPS receiver 130, Wi-Fi module 140 and the like. The mobile electronic device 100 may contain additional power consumption modules, or provide power to external power consumption modules, such as an external memory drive, a web camera and the like. The mobile electronic device 100 comprises two or more power suppliers 112, 114, 115, 116, 118, such as batteries, which provide power to the two or more power consumption modules disclosed above. The two or more power suppliers 112, 114, 115, 116, 118 may be included in the mobile electronic device 100 in addition to a main device battery which provides power to all the power consumption modules. The mobile electronic device 100 comprises a computerized control unit 160 for determining a configuration in which power is supplied to the two or more power consumption modules by the two or more power suppliers 112, 114, 115, 116, 118. The computerized control unit 160 may change the power supplier allocated for a specific power consumption module. For example, in case the GPS receiver 130 requires more power, the computerized control unit 160 may allocate power suppliers 112 in addition to power supplier 116 which is dedicated to the GPS receiver 130 whenever the GPS receiver 130 is on. The computerized control unit 160 may change allocation of the power suppliers responsive to a predefined event or rule, or according to a command inputted into an input unit of the mobile electronic device 100. For example, when the display device 120 displays a video file of more than 3 minutes, the power supplier 118 is allocated to the display device 120 by the computerized control unit 160. The computerized control unit 160 may allocate power suppliers to power consumption modules in order to optimize the performance of the power consumption modules, or in order to optimize the total efficiency of at least two of the power suppliers.

The two or more power suppliers 112, 114, 115, 116, 118 may be stored in two or more physical compartments in the mobile electronic device 100. For example, one compartment may be located near the display device 120 while another compartment may be located closer to the Wi-Fi module 140. In such a case, the computerized control unit 160 may consider the distance between the compartments of each power supplier when allocating a power supplier to a power consumption module. The two or more power suppliers of the mobile electronic device 100 may vary in various properties, such as size, shape, charging technology, power transfer technology, watt provided by each power supplier and the like.

In FIG. 1B, each power supplier supplies power to a single predefined power consumption module, according to exemplary embodiments of the subject matter. For example, power supplier 112 supplies power to GPS receiver 130, power supplier 116 supplies power to display unit 120, power supplier 114 supplies power to Wi-Fi module 140 and power supplier 127 supplies power to touch sensors 125.

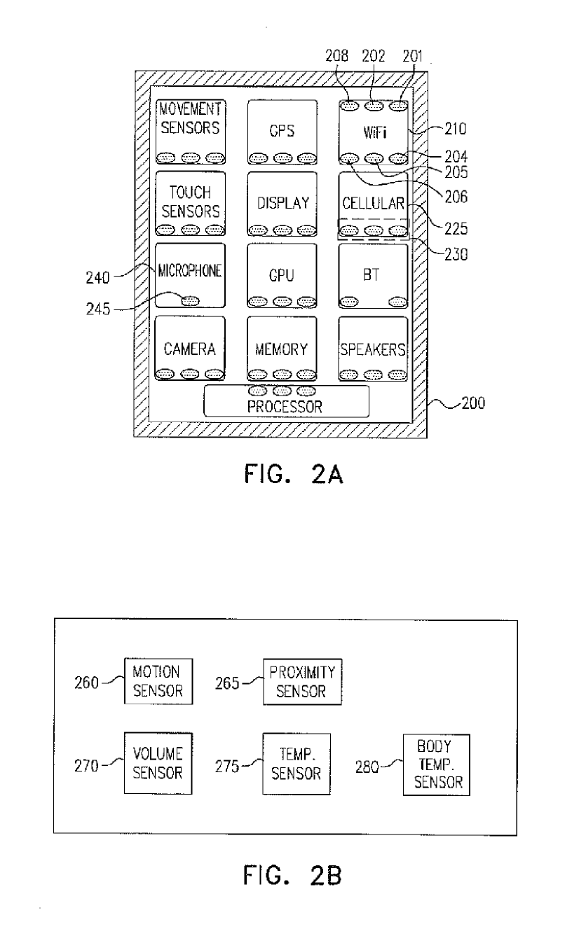

FIG. 2A shows an optional configuration of power supply configuration in which power suppliers are allocated to power consumption modules, in accordance with a preferred embodiment of the invention.
The power supply configuration defines which power suppliers or an array, bundle or package of power suppliers, is allocated for at least a portion of the power consumption modules of the mobile electronic device. The power supply configuration is adjustable by a computerized unit of the device as disclosed above. At least some of the power consumption modules of the electronic device receive power from various power suppliers that may vary in size, power, capacity, number and additional properties. For example, the Wi-Fi module 210 receives power from six (6) power suppliers 201, 202, 204, 205, 206, 208. The indication of some of the power suppliers, such as power supplier 201, may represent power from a known and predefined plurality of power suppliers. The cellular module 225 receives power from three (3) power suppliers 230 bundled together, which means that all three power suppliers, for example batteries, can only be allocated to the same power consumption module. In another exemplary case, microphone 245 receives power from power supplier 240, which is located in a compartment closest to the microphone 245. In some exemplary cases, some power consumption modules receive a different amount of power than others, or receive power from a different number of sources, or from a different number of power suppliers located at the mobile electronic device. The map may be displayed on a display device 200 of the mobile electronic device.

FIG. 2B shows an optional configuration of power supply configuration in which power suppliers are allocated to various sensors, in accordance with a preferred embodiment of the invention. The power supply configuration for the various sensors provides the power suppliers for various sensors, such as (but not limited to) motion sensor 260, proximity sensor 265, volume sensor 270, temperature sensor 275 and body measurements sensor 280. Additional sensors, such as accelerometer, may also have their power allocation adjusted in the method and system of the disclosed subject matter.

The embodiments disclosed in FIG. 2A or 2B may lack a display device, and may further comprise a wireless communication unit, as used in watches and Internet of Things devices, wearable devices and the like.

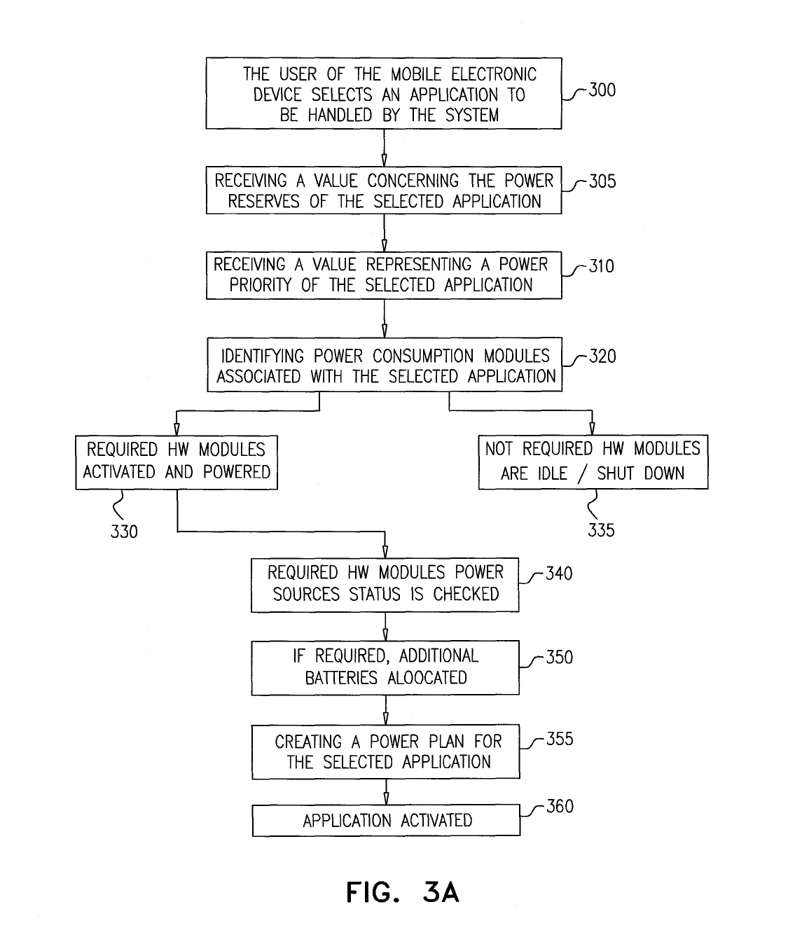

FIG. 3A shows a method for allocating power suppliers to power consumption modules, according to exemplary embodiments of the disclosed subject matter. In step 300 the user of the mobile electronic device selects an application to be handled by the system of the disclosed subject matter. Such application may be a software application, such as a news application or an application that uses a hardware module, such as a camera or a communication module. Step 305 disclose receiving a value concerning the power reserves of the selected application. The received value may be inputted by a user of the mobile electronic device, for example via an input unit of a signal from another device. Such inputted value may indicate a power threshold below which the application will not receive power at all, or a power threshold that when surpassed, another application will automatically be terminated, or additional batteries will be allocated to the selected application. Step 310 discloses receiving a value representing a power priority of the selected application. The power priority may be received by the user of the mobile electronic device, for example in order to rank the importance of at least a portion of the applications running on the mobile electronic device. The priority value may indicate that when required, half of the power may be allocated to the selected application, and less power will be allocated to other applications. The values received in steps 305 and 310 may be received from a user of the device, or from a remote device such as a messaging server, or automatically by a module of the power management unit.

Step 320 discloses identifying power consumption modules associated with the selected application, for example hardware modules. The identification may be performed by the computerized control unit disclosed above, or via a table that lists power consumption modules per applications. For example, a new application may require the display device and Wi-Fi, but not require a GPS module to be activated. Then, in step 330, the required power consumption modules are activated, or kept in an activated state. Similarly, step 335 discloses deactivating power consumption modules that are not required for the operation of the selected application. In some exemplary cases, more than one application is selected, or some power consumption modules are kept activated at all times, or without regard to the selected application, for example a touch sensor. Then, in step 340, the status of the required power consumption modules is checked, for example by the computerized control unit, for example to check their actual power consumption. Step 350 discloses allocating additional power suppliers to the power consumption modules, in case the previously allocated power suppliers do not meet a power requirement or any other predefined rule. Such rule may be a time elapsing since the power consumption modules began consuming power, or began consuming power higher than a predefined threshold. Allocating the power may take into account usage habits stored in a computerized storage of the mobile electronic device. Such usage may be of the specific application selected by the user, or usage of many users received from a remote device or from the cloud. The usage habits may be part of a power plan created in step 355. The power plan may include allocation of power suppliers to software applications or power consumption modules. The power plan may include minimal and maximal power usage thresholds to various software applications or power consumption modules. The power plan may include means to set these configurations in accordance to user's defined priorities. The power plan may use information from some applications running on the mobile electronic device, for example the user's calendar and navigation unit. For example, in case the user is expected to spend a lot of time on the road according to his calendar, the usage may change accordingly. After the correct power suppliers are allocated to the relevant power consumption modules, the application selected by the user is activated 360.

FIG. 3B shows a method for prioritizing power consumption modules when allocating power, according to exemplary embodiments of the disclosed subject matter. Step 370 discloses obtaining power priorities for one or more applications operating on the mobile electronic device. For example, the email application should run as long as there is power left in any of the power suppliers. The power priority may be inputted via an input unit of the mobile electronic device, for example by ranking the applications in a configuration that the lowest priority will be the first one to not receive power from any power supplier, according to predefined rules stored in a storage of the mobile electronic device. In some cases, the user may input priorities with regard to a portion of the applications, for example in case there is a communication module or a security module that should work all the time, due to company policy. The power priorities inputted by the user may also include reservation thresholds, below which the application will not receive power from the power suppliers. For example, in case the power in the power suppliers can be used for 10 more minutes, all applications are automatically turned down, besides the dialer. Step 372 discloses identifying power consumption modules that correlate to the applications prioritized by the user. Then, according to the identification, step 375 discloses that power consumption modules that have a higher priority may be charged first and step 378 discloses that power consumption modules that have a lower priority may be charged later. The mobile electronic device may have charge each batter separately. The mobile electronic device may charge all batteries from a single charging source. The mobile electronic device may have means to manage and/or switch charging power to the batteries. The mobile electronic device may include a management/control computer program to prioritize charging of batteries. The prioritization may include user's configurations, pre-defined thresholds, available charging time and the like.

Step 380 discloses checking the charging status of the power consumption modules. Such check may be performed periodically, for example every 90 seconds. In some cases, another battery may be allocated for charging, as shown in step 385, for example a battery allocated to a low priority power consumption module will transfer power to a power supplier allocated to a high priority power consumption module, such as a display device. In some cases, the mobile electronic device may comprise a back-up power supplier which transfers power to the power supplier allocated to a high priority power consumption module according to a predefined rule. The process ends when the batteries are charged as shown in step 390.

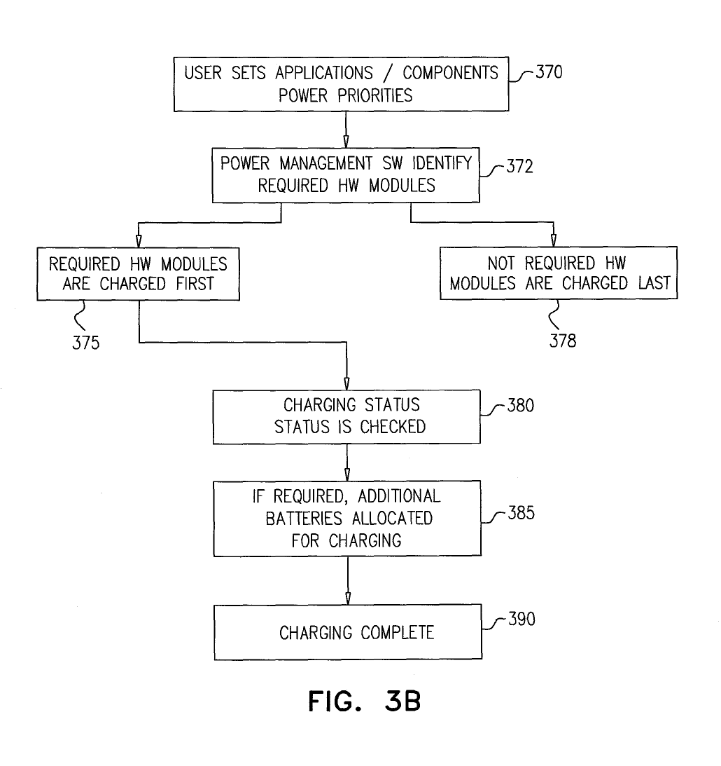

FIGS. 4A and 4b show an arrangement of multiple power suppliers in a power compartment, according to exemplary embodiments of the disclosed subject matter. Power supplier 410 shows a single power supplier consuming the volume of a power compartment of the mobile electronic device. Alternatively, three power suppliers 420, 425, 430 are positioned in the same power compartment, for example in case each of the three power suppliers 420, 425, 430 has a width which is one third of the width or the power supplier 410. When using three power suppliers 420, 425, 430 of the same power compartment, all three may be connected to a power connector 440, in order to be able to seamlessly replace the single power supplier 410 in the mobile electronic device. In such a case, the power connector has three ports 442, 445, 448, each port is used to be connected to one of the three power suppliers 420, 425, 430. When the power capacity of each of the three power suppliers 420, 425, 430 is higher than one third the power capacity of the power supplier 410, the power transferred from the power compartment is higher. In some cases, the three power suppliers 420, 425, 430 may have the same width, and each have a height of one third of the height of the power supplier. In some cases, as shown in FIG. 4B, the power supplier 430 may be replaced by two power suppliers 440, 445, to further increase the power transferred by the power compartment.

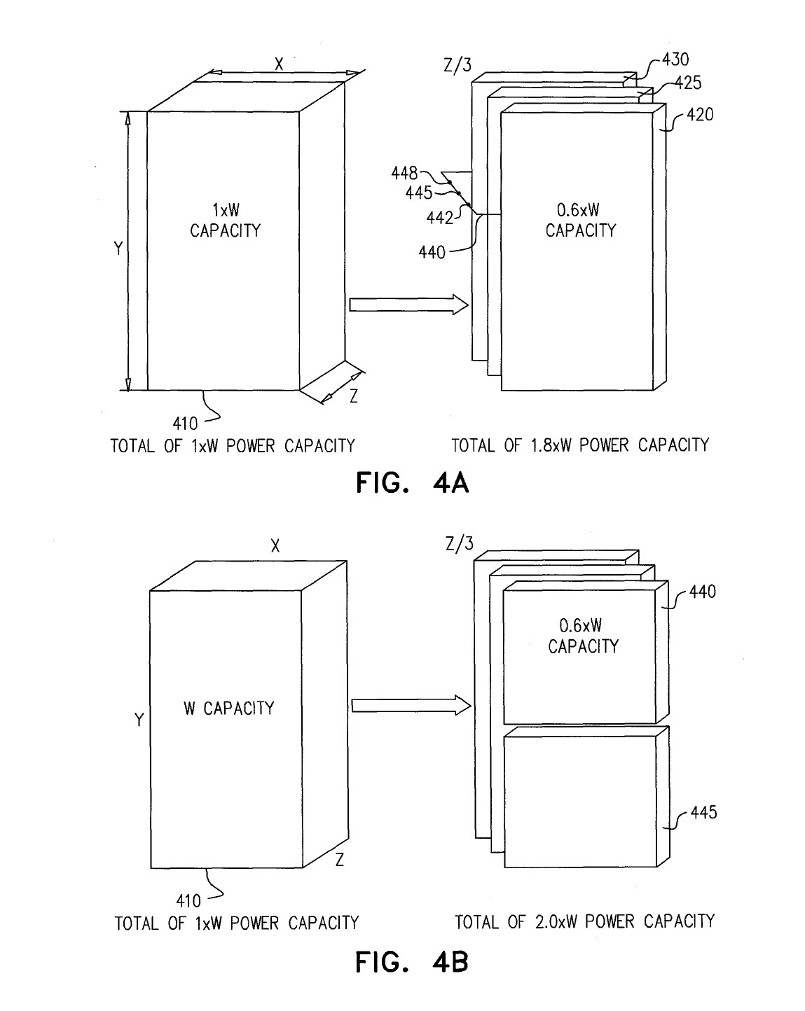

FIG. 5 shows a table that shows usage of multiple power suppliers, according to exemplary embodiments of the disclosed subject matter. The table illustrates the benefit of using a distributed array of power suppliers with reduced capacity over a single battery, assuming the array and single battery occupy the same space in the device. The table consists of three column, a first column 510 shows the power capacity per battery, the second column 520 shows the number of batteries in a predefined space. The space may be defined by length or height of a compartment, or the compartment's volume. The third column 530 shows the total power provided by the compartment, which is a multiplicity of the value from the first column 410 and the second column 520 in each row.

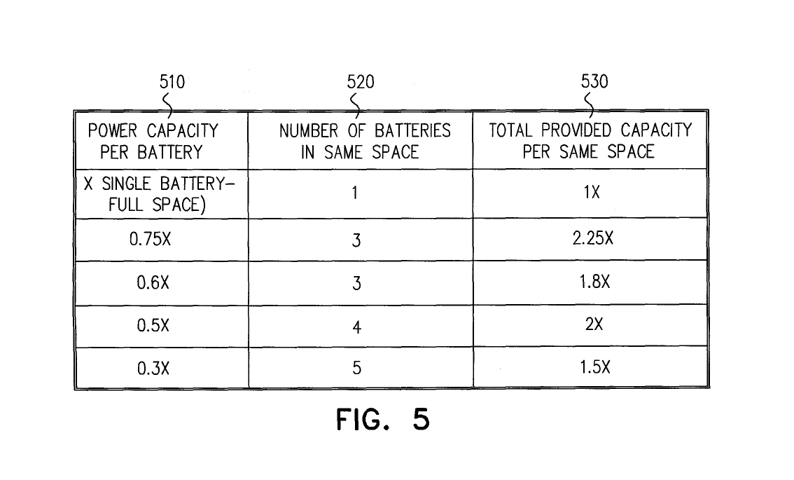

FIGS. 6A-6C show several sections of a display device having power allocated thereto in a separate configuration, according to exemplary embodiments of the disclosed subject matter. FIG. 6A shows a mobile electronic device having a main display device 620 and two secondary display units 610, 630 connected to the main display device 620. The secondary display device 610 may be removable from the mobile electronic device 600, and when connected to the main display unit 620, may be foldable on the main display unit 620, or scrolled on it, in a direction represented by arrow 615. Similarly, secondary display unit 630 may slide on the main display device in a direction represented by arrow 635. In some cases, the two secondary display units 610, 630 are virtual and separated from the main display unit 620 by software, and can be united together when determined by a processor of the mobile electronic device 600. The main display unit 620 and the two secondary display units 610, 630 may receive power from separate power suppliers, at least some of the time, according to power properties and priorities disclosed above, such as distance from the power supplier, software running on each display section, type of content displayed on each display section and the like.

FIG. 6B shows a display device having three display segments 611, 621, 631. Display segment 611 receives power from all the power suppliers, for example in case the display segment 611 is used for a gaming application. Display segment 621 receives power from power supplier group 624 and power supplier group 622. The display segment 621 may be used for text messages and needs less power than the display segment 611. The power supplier groups 624, 622 may also provide power to the display segment. Display segment 631 receives power from supplier groups 634, which may be equivalent to supplier group 624. The display segment 631 may be used for simple control actions and for the dialer. In some cases, the power supplier group 624 may include batteries of a different types than the batteries included in power supplier group 622. In some cases, one of the display segments may have display properties or definitions, for example display segment 631 may be limited to grayscale.

FIG. 6C shows a display segment 650 used for text only, a main display segment 655 used for all the applications operating on the mobile electronic device 600 and a display segment 660 having the ability to create bumps 662, 664, 666, 670 in the display surface. The multiple display sections may vary in operation parameters such as size, technology, power consumption, resolution and the like. At least some of the display sections may be transparent, bendable, stretchable, elastic, curved, or somehow change in shape or size. Some display sections may be dedicated to specific applications or power consumption modules, or change their functionality and power consumption responsive to a predefined event or command. According to this embodiment, each display can operate independently, via its own power source, while the other displays may be turned off to preserve battery power.

Said electronic device may include a computer program and/or algorithms to enable the user to assign different power to different zones or areas in a display or to do so or automatically. Such assignment can be based on the currently viewed software application, may be based on algorithms demand with the applied software application in the display unit. The display unit may be configured and produced in such configuration that it includes zones associated with selective power consumption rate. The mobile electronic device may include means to enable a software application to selectively choose a preferred said zone (for example, to offer reduced power consumption by the application. The mobile electronic device may include means to automatically assign display zones to software applications. The mobile electronic device may include means to prioritize assignment of said zones to software applications based on available power supply, software application power consumption, user usage habits and other parameters.

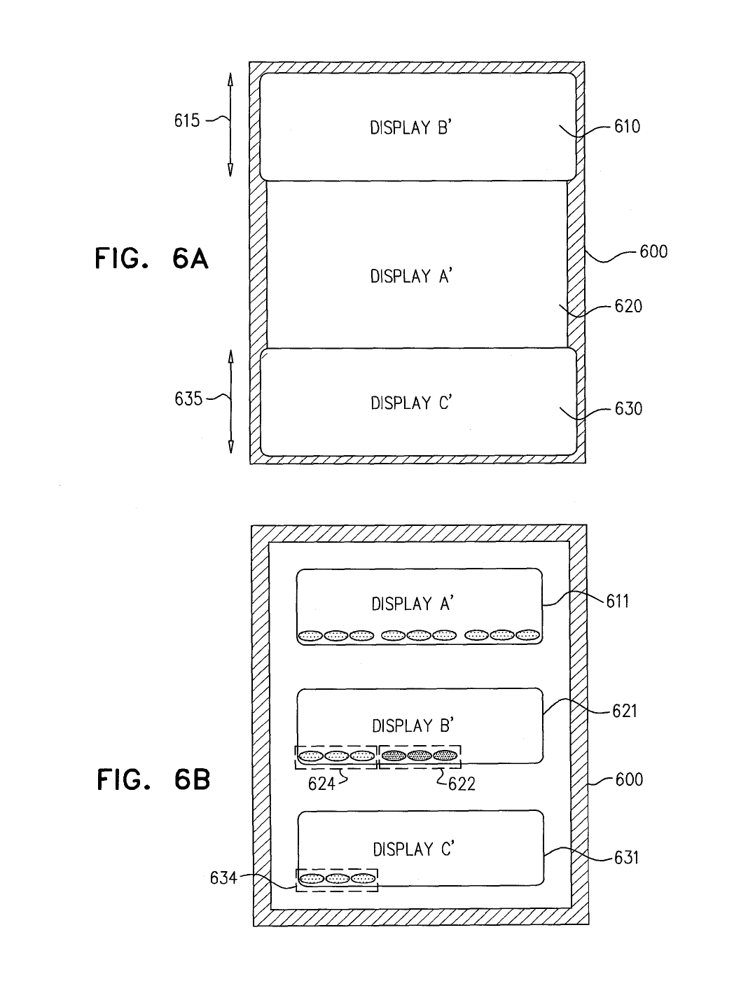

FIG. 7 shows a method of controlling power allocation to a mobile electronic device from a remote device, according to exemplary embodiments of the subject matter. Step 710 discloses wirelessly transmitting information concerning power supplier status to a remote device. For example, a parent monitoring battery status of a child, or an employer monitoring an employee. The mobile electronic device may comprise a monitoring unit that enables a remote device to a remote user to remotely view, manage, configure, allocate, assign, prioritize and mange the distributed power configuration of another device. In step 720 the person using the remote device inputs commands or values that is wirelessly transmitted to the monitoring unit of the mobile electronic device. Such commands or values may be priorities of various power consumption modules or software applications operating on the mobile electronic device. Step 730 discloses the person using the remote device initiating an alert concerning the power status of one or more batteries, which results in an indication, for example on the display device, to charge the mobile electronic device. In step 740 the person in the remote device receives an indication that the mobile electronic device is charged, at least in some of the power suppliers, and the person in the remote device is enabled to access the monitoring unit and adjust some of its rules or settings. In step 750, the person using the remote device prevents or limits the user of the mobile electronic device from using one or more power consumption modules or software applications. In another example, a parent may set priorities to medical sensors of his child device over other SW applications—for example, #1 priority is for glucose monitoring software for diabetics, #2 priority is for emergency call #3 for location sensors and so on. This configuration may shut down other software applications and/or hardware components if required—for example, will prevent the child from playing video games, do photo editing, surf the web and the like.

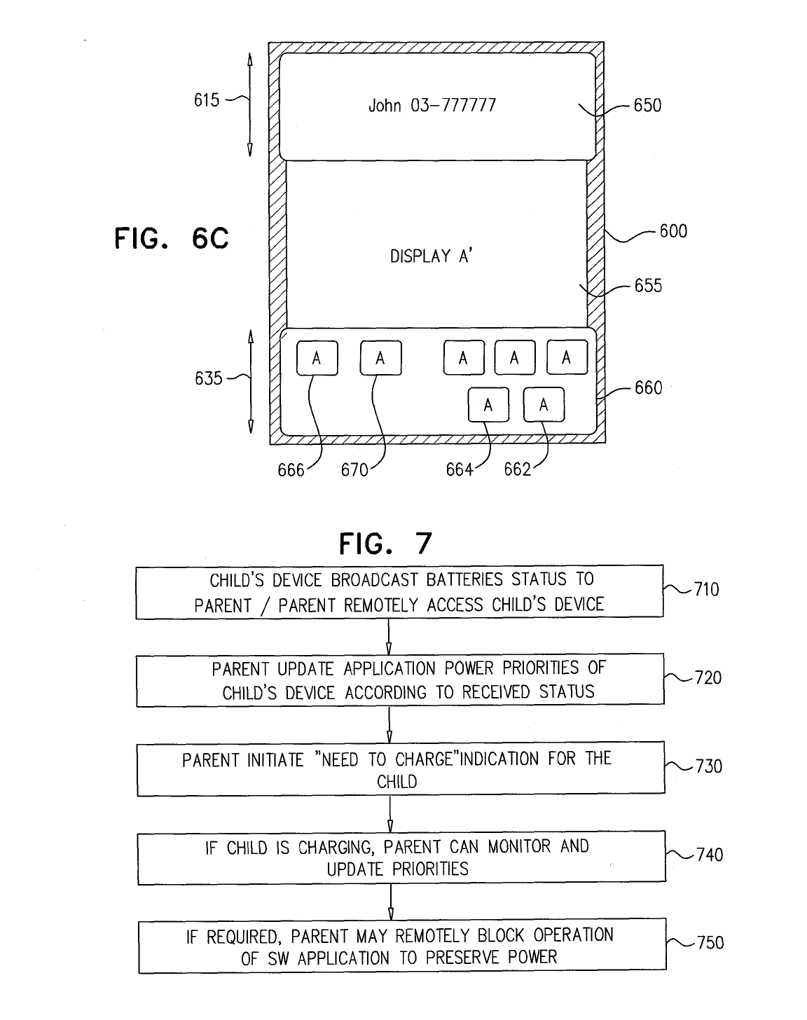

FIG. 8 shows a packaging of an array of power suppliers to a mobile electronic device, according to exemplary embodiments of the subject matter. The array of power suppliers 852 may be located near a main battery 850 to provide power to one or more power consumption modules, such as a processor 830. A switch 810 may be used to physically adjust power allocation from the plurality of power suppliers 852 to the power consumption modules. The processor 830 may determine which power suppliers are allocated to which power consumption modules, for example according to battery type, size, technology, power and the like. In some cases, power provided to the power consumption modules may be obtained via a solar panel 840 in conjunction with at least one of the power suppliers, which may be charged by a charger 820. The solar panel 840 may also be used to charge power and may be connected and/or integrated to specific power consumption module, for example, a display unit may include a solar panel 840 that will be used for the operation of the display unit only. The solar panel 840 may be connected to the entire distributed battery array and/or only to a specific battery in the array. In a possible configuration when a 11W component has a battery attached thereto, said solar panel 840 may be connected to this battery. In some cases, the solar panel 840 may be integrated into the distributed battery array.

The distributed battery array that may be packaged in a dedicated packaging. The package may include at least one battery, and distribute power to various power consumption modules. The distribution can be performed internally in the package, between batteries, for example via internal charging inside the package.

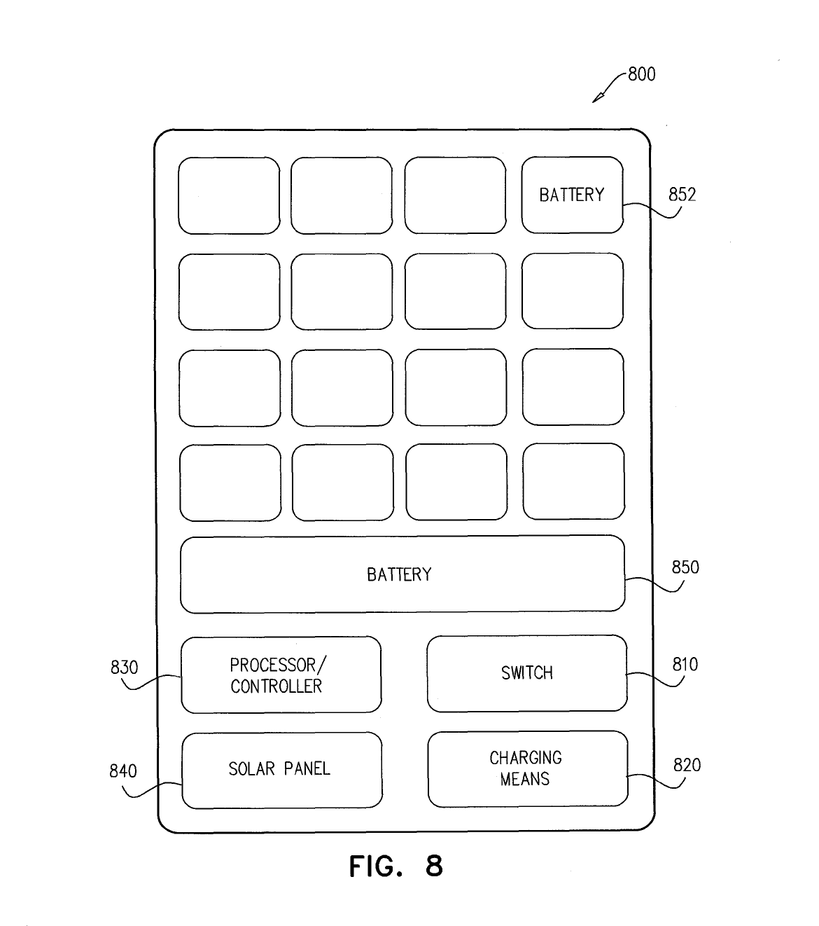

FIG. 9 shows a power supplier with sub-units of another power supplier in a power compartment, according to exemplary embodiments of the subject matter. The sub-units may be contained in an adaptive power compartment 900 residing inside the mobile electronic device. The power compartment 900 may be equipped with physical connectors for transferring power from the various sub batteries to the power consumption modules of the mobile electronic device. The power compartment 900 may include a main sub-battery 910 and additional sub-batteries 920, 922, 925, 930.

At least one of said sub-battery modules may be operated and/or charged independently and/or selectively. The battery unit may be operated and/or charged as a unified single unit. In some cases, at least some of the sub-battery modules may be built from different materials. In some other cases, at least a portion of the said sub-battery units may provide different power capacity and/or output, or provide different usage time. In some cases, some of the said battery modules may be of different size, shape, thickness, density and the like. At least some of the said sub-battery modules may be assigned to a different software application and/or different power consumption module in the mobile electronic device. The battery unit may include switching means.

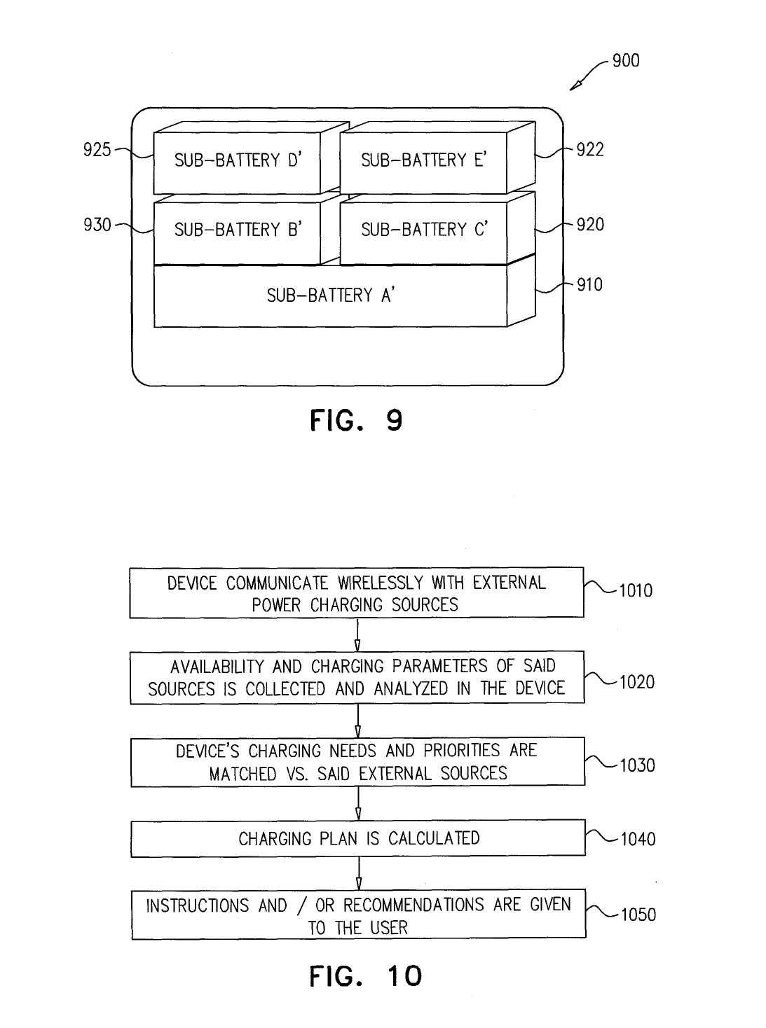

FIG. 10 shows a method of charging a mobile electronic device from a remote device, according to exemplary embodiments of the subject matter. Step 1010 discloses establishment of wireless connection between the mobile electronic device and a remote device, said remote device has a power charging unit. Step 1020 discloses the mobile electronic device receiving information concerning the availability of the charging unit to transfer power to power consumption modules of the mobile electronic device. Step 1030 discloses matching power charging needs of power consumption modules of the mobile electronic device with the availability of the charging unit of the remote device.

Step 1040 discloses determining a charging plan according to the matched information above. The charging plan may consider Said prioritization may take into consideration parameters such as user's preference, external power charging time, external power charging availability (for example, if currently charging another device), external power charging source waiting-list queue and time, internal batteries types and status that needs to be charged, software application priorities, power consumption modules priorities, the location of the mobile electronic device, the time required to charge at least some of the batteries and the like. Step 1050 discloses generating an alert or a message to the user of the mobile electronic device concerning how to use the charging unit of the remote device.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A mobile electronic device, comprising:
two or more power consumption modules;
two or more power suppliers for providing power to the two or more power consumption modules;
a computerized control unit for adjusting a configuration in which power is supplied to the two or more power consumption modules by the two or more power suppliers from a first power supply configuration to a second power supply configuration.

2. The mobile electronic device of claim 1, further comprises a display device for displaying a map of associating the two or more power suppliers and two or more power suppliers.

3. The mobile electronic device of claim 1, further comprises an input unit for receiving an input from a user of one of the two or more power consumption modules, said input concerns allocation of one of the two or more power suppliers to the one of the two or more power consumption modules.

4. The mobile electronic device of claim 1, wherein a first power supplier of the two or more power suppliers has a different property than a second power supplier of the two or more power suppliers.

5. The mobile electronic device of claim 1, wherein a first power supplier of the two or more power suppliers is identical to a second power supplier of the two or more power suppliers.

6. The mobile electronic device of claim 1, further comprises a switching unit connected to the computerized control unit for changing allocation of a power supplier of the two or more power suppliers to the one of the two or more power consumption modules.

7. The mobile electronic device of claim 6, wherein the switching unit enables a power supplier of the two or more power suppliers to function when another power supplier of the two or more power suppliers cannot supply power.

8. The mobile electronic device of claim 6, wherein changing allocation of a power supplier of the two or more power suppliers to the one of the two or more power consumption modules responsive to a predefined event or a predefined set of rules.

9. The mobile electronic device of claim 1, further comprises a transmission unit for transmitting indication concerning battery status of at least one of the two or more power suppliers to a remote device.

10. The mobile electronic device of claim 9, wherein the transmission unit is configured to transmit an indication concerning battery status responsive to a predefined event.

11. The mobile electronic device of claim 1, further comprises a monitoring unit that enables a remote device to remotely monitor power consumption of the two or more power consumption modules.

12. The mobile electronic device of claim 1, further comprises a physical connector to enables replacing a single power supplier with two or more power suppliers, such that each of the replacing two or more power suppliers can supply power to the two or more power consumption modules.

13. The mobile electronic device of claim 1, further comprises two or more compartments for storing the two or more power suppliers, wherein a power supplier of the two or more power suppliers adapted to provide power to a specific power consumption module is stored in a compartment located near the specific power consumption module.

14. The mobile electronic device of claim 1, further comprises a charging connector configured to charge a portion of the two or more power suppliers simultaneously.

15. The mobile electronic device of claim 1, further comprises an internal power charging unit for transferring power between power suppliers of the two or more power suppliers.

16. The mobile electronic device of claim 1, wherein a package of power suppliers of the two or more power suppliers are dedicated to a specific power consumption module of the two or more power consumption modules.

17. The mobile electronic device of claim 1, further comprises a solar charging unit for absorbing light from an external source and converting the light to electrical power.

18. A method for managing power allocation in a mobile electronic device comprising;
obtaining a mobile electronic device, comprising two or more power consumption modules and two or more power suppliers for providing power to the two or more power consumption modules;
adjusting a power supply configuration in which power is supplied to the two or more power consumption modules by the two or more power suppliers from a first power supply configuration to a second power supply configuration.

19. The method of claim 18, further comprises receiving a value indicating a priority of one of the two or more power consumption modules and adjusting the configuration in which power is supplied to the two or more power consumption modules according to said value.

20. The method of claim 18, further comprises receiving a value indicating a power reserve of one of the two or more power consumption modules and adjusting the configuration in which power is supplied to the two or more power consumption modules according to said value.

21. The method of claim 18, further comprises receiving a value indicating a charging status of one of the two or more power consumption modules and adjusting the configuration in which power is supplied to the two or more power consumption modules according to said value.

22. The method of claim 18, wherein adjusting a configuration in which power is supplied to the two or more power consumption modules comprises activating or deactivating one of the two or more power consumption modules.

23. The method of claim 18, wherein adjusting a configuration in which power is supplied to the two or more power consumption modules according to an application operating on the mobile electronic device.

24. The method of claim 18, further comprises displaying a map of associating which power supplier supplies power to each power consumption module.

25. The method of claim 18, wherein adjusting a configuration in which power is supplied to the two or more power consumption modules is performed in response to a command from a remote device.

26. The method of claim 25, further comprises monitoring power allocation of the two or more power consumption modules from the remote device.

27. The method of claim 25, further comprises determining a power allocation plan of the two or more power consumption modules at the remote device.
